(19) United States
(12) Patent Application Publication
(10) Pub. No.: US 2003/0026645 A1
(43) Pub. Date: Feb. 6, 2003

(54) Novel articulated and or rigid joinery

(76) Inventor: Clare L. Hoke JR., Upland, CA (US)

Correspondence Address: Clare L. Hoke Jr., Suite 11, 1318 N. Monte Vista Ave., Upland, CA, 91786, US

(21) Appl. No.: 09/918,761

(22) Filed: Aug. 1, 2001

(51) Int. Cl. B25G 3/00; F16B 7/08; F16B 9/00; F16L 41/00

(52) U.S. Cl. 403/230

(57) ABSTRACT

A novel joinery technique, capable of rigidity, articulation, and modularity, featuring simple fabrication and customization, for use in woodworking, furniture, cabinetry, and architecture.

### BACKGROUND OF THE INVENTION

1. Field of Invention

The present invention relates to wood and or metal working, furniture, cabinetry, and architecture. Specifically discussed is a joint/hardware, capable of rigid joinery, lateral articulation, (movement) axial articulation, and methods for fabrication thereof.

2. Description of Prior Art.

Joinery predates recorded history. Civilizations which have been geographically or culturally isolated have developed unique variations on joinery techniques; Japanese vs. German Joinery for example. Similarly, certain eras have emphasized joinery preferences, either for technical abilities, or fashion peccadilloes. With the passing of Joinery Guilds, information on the history and techniques of Joinery have been well documented on a global basis. Joinery represents a crowded art, where decades may pass before subtle developments may be recognized. Recent developments in the field of joinery have involved the employment of new man made materials and adhesives, far more extensively than mechanical design improvements.

Cabinet and architectural hardware has followed a near identical historical path as joinery, with its inception predating recorded history. Recently design and functional changes have accelerated in the hardware markets, due in part from increased market demand, and reduced start up costs derived from technological advances. These technological benefits are still outside the realm of small businesses however. For example, small cabinet shops must fill the demand for custom hardware solutions from stock parts available through hardware suppliers. The ability to custom fabricate hardware solutions is outside the realm of the majority of furniture, cabinet, or architectural firms.

The present invention will serve to provide multiple solutions for artisans, as well as furniture, cabinet, and architectural firms. Serving in two forms, the present invention may be employed as joinery, in a non articulating manner, or may function as a new type of articulating hardware. As such the Present Invention broaches the line between joinery and hardware. The process of fabrication also places the Present Invention, and its multiple custom variations within the abilities of furniture, cabinet, and architectural firms, large or small.

### SUMMARY OF THE PRESENT INVENTION

Accordingly, several objects and advantages of the present invention include:

1). Aesthetically beautiful joinery

2). Esthetically pleasing hardware

3). Ease of fabrication

4). Low cost

5). Increased opportunity for custom applications

6). Multiple custom variations of the Present Invention may be readily conceptualized and readily executed to fill needs of artisans as well as furniture, cabinet and architecture firms

7). Extremely high lateral stability when either employed as rigid joinery, or when employed with articulation

8). The Present Invention may be employed in a fixed manner, may be employed with lateral articulation, may be employed with axial articulation, and may be employed with any combination of the above in multiple variations

### BRIEF DESCRIPTION OF DRAWINGS

FIG. 1 Depicts a cross sectional view of the Present Invention.

FIG. 2 Depicts a variation of the preferred embodiment of the Present Invention in cross section.

### DESCRIPTION OF THE PREFERRED EMBODIMENTS

In wood, metal, furniture, cabinetry and architectural work, joinery refers to the unification of two or more separate objects, with the implication of melding, so as to render the two or more said objects as indistinguishably united; while hardware refers to objects which may serve to join, articulate, provide functionality and or decorate, but remain distinct from the materials and or the concept of seamless union. The Present Invention exhibits novel versatility in that it may be employed as joinery, in a rigid manner, and may also function as a new type of hardware, capable of lateral and axial movement, and modularity. The preferred embodiment of the Present Invention represents the best of both classical and modern perspectives in that while it may employ modem materials, adhesives and novel techniques, the Present Invention is not bound strictly to modern materials or specific techniques to function properly.

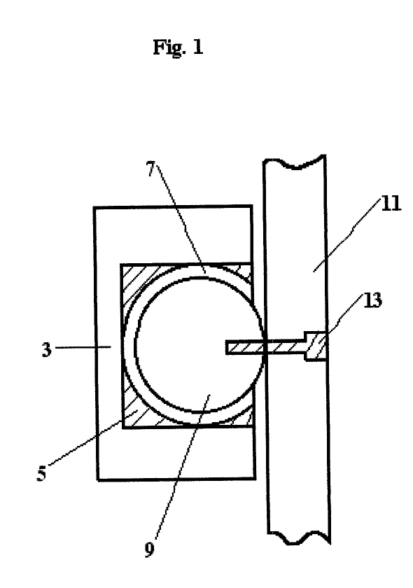

FIG. 1 shows a cross sectional perspective of the preferred embodiment of the present invention. Part 3 represents material and or a housing wherein a channel 5, is formed. Part 7 represents a sleeve or tube which is to be placed within channel 5. If a particular design requires the length of a resultant part be short enough that part 3 may be bored directly, or if part 3 may be extruded, formed, or in some other way fabricated so that the diameter of the opening in part 3 is functionally proximal the shape of part 7; formed and in fact structurally adequate to alleviate the channel aspect 5 formed in part 3 (ie. snug), or fabricated in such a way to alleviate the need for part 7 entirely, then the following procedure of filling channel 5 may be avoided.

Because the preferred embodiment of the present invention incorporates bringing multiple variations of the Present Invention and fabrication thereof within the grasp of most artisans, fabricators and firms, it is herein suggested that in the preferred embodiment of the Present Invention, channel 5 may be filled with adhesives and or additives, said combination being capable of adhering part 3 to part 7, and exhibiting appropriate structure: said adhesives including but not limited to Epoxy, Resin, Polyester, and Water, based adhesives; with said additives including but not being limited to saw dust, iron oxide, semi precious minerals, graphite, fiberglass, kevlar, or powdered metals, for reasons of appearance or structure.

In the preferred embodiment of the Present Invention part 9 is depicted as a solid dowel. Clearly this aspect may be replaced with a sleeve, sleeve/dowel combination, mosaic, or any number of variations thereof. Likewise the materials employed in all aspects of the preferred embodiment of the present invention are non determinative, and interchangeable. The tolerances between sleeve 7 and dowel 9 in the preferred embodiment of the Present Invention are capable of extreme variation as well, depending upon application. In practice, part 7 is breached axially to permit the joining/fastening of a second object 11 to part 9. The various radii of part 9, as well as the various possible breach sizes to part 7, serve to determine the tolerances between part 3, and part 11. Part 13 represents a machine or wood screw which is employed to fasten part 11 to part 9.

In fabricating the preferred embodiment of the Present Invention, part 3 is produced larger on the open end of channel 5, so that part 7 may be fully emersed in adhesives, and potentially adhesives including additives. After curing, parts 3, 7, and the adhesives in part 5, are cut so as to expose a breach within part 7. In practice, cutting so as to expose a breach within part 7, may be accomplished with a band saw, vertical end mill, wide belt sander, router, sander, or other various common methods. The practitioner will want to consider the amount of heat generated per method of cutting, as heat will effect certain adhesives detrimentally.

With part 7 breached axially, part 9 may articulate laterally within part 7, forming a slide or pull. As such the Present Invention may function as hardware, and may be employed as a modular hardware unit, the sum of parts, 3, 5, 7, being planted upon, or embedded within objects or materials, and part 9 being employed in a modular manor with regard to part 11, and previously mentioned parts 3, 5, 7. Clearly part 3 may be omitted in the instance where part 3 becomes integral with the work being fabricated. Likewise, the clearance, or tolerance, between part 3, and part 11, may serve to enable axial movement, as well as lateral movement as required in certain applications.

Focusing further upon parts 3, 5, 7, 9, and 11, it should become evident that by employing appropriate materials, and additional adhesives, the above mentioned parts would readily serve to form a non articulating joint between two or more objects. This would be esthetically pleasing in a high end art, or architecture work wherein a combination of articulating and non articulating variations of the Present Invention would be employed. As such, further variations of the preferred embodiment of the Present Invention serve to embrace a traditional perspective of joinery.

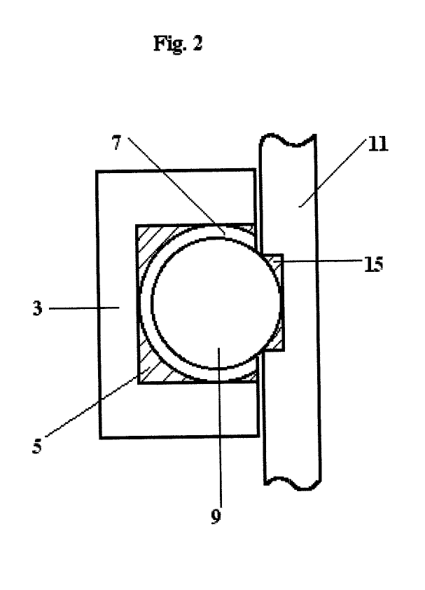

Part 13 provides an expedient and blind method of fastening part 11, to part 9. When part 13 (a wood or metal screw) is exchanged for a dowel, or spline, a seamless sense of true joinery may be attained. Further, by increasing the surface area between part 9, and part 11, the concept of joinery as described herein, will be embraced. This may be achieved by increasing the flat, circular, or angular surface area between parts 9, and 11. Likewise, a variant of parts 3, 5, 7, may be employed to embrace part 9, in similar manner, so as to appeal to a traditional sense of joinery, as depicted in FIG. 2. Herein channel 15 is employed in part 11, channel 15 being filled with adhesives and or adhesives with additives to eliminate the need for part 13. The variation depicted in FIG. 2 is capable of rigidity as well as articulation.

What I claim is:

1. A joint comprised of:
An object or material containing a largely circular void, said object being breached axially so as to permit a second object or material inserted within said void to be attached to a third object or material so as to form a rigid connection between three objects or materials.

2. A joint as described in claim 1, wherein:
said three objects or materials may be fused by formation, adhesion, or fastening so as generate two, or one composite objects and or materials.

3. A joint as described in claim 2, wherein:
said first object or material is capable of articulation in a linear manner along said axial breach with regard to said second and third objects or materials.

4. A joint as described in claim 2, wherein:
said first object or material is capable of axial articulation along said axial breach with regard to said second and third object or material.

5. A joint consisting of:
A first object containing within it a largely circular void in section, said first object being breached so as to allow access to said largely circular void in an axial manner along the length of said axial breach, wherein a second object, conforming so as to fit within said circular void, is placed within said largely circular void, said second object being connected to a third object, via said breech in said first object.

6. A joint as described in claim 5, wherein:
Said joint is capable of rigidity, or articulation of said first object with regard to said second and third object via. said axial breach in said first object.

7. A joint consisting of:
A first object containing within it a largely circular void, said void being axially breached so as to allow access to said largely circular void along the length of said axial breach, wherein a second object, conforming so as to fit within said circular void, may be placed within said largely circular void, said second object being formed in such a manner as to extend from within said largely circular void, through said axial breach in said first object to be attached to a third object.

8. A joint as described in claim 7, wherein:
Said third object is formed in such a manner as to contain said second object as an integral manner.

9. A joint as described in claim 8, wherein:
Said joint is capable of rigidity, or articulation of said first object with regard to said second object via. said axial breach in said first object.

10. A joint comprised of:
A first object housing a channel, said channel containing a sleeve, said sleeve being largely circular and secured in said channel by adhesives and or, adhesives with additives, said sleeve being breached axially so as to permit tangential connection between a second sleeve or rod, held within first said sleeve and a third object.

11. A joint as described in claim 10 wherein:
said joint is capable of rigidly connecting or capable of articulating said first object with regard to said second sleeve or rod.

12. A joint as described in claim 11 wherein:
said second sleeve or rod may be formed as an integral part of said third object.

13. A joint as described in claim 11 wherein:
said third object may contain a channel as in the first said object, so that the second said sleeve or rod may be affixed within it in like manner to the first said object, and first said sleeve.
